(19) United States
(12) Patent Application Publication
(10) Pub. No.: US 2008/0096074 A1
(43) Pub. Date: Apr. 24, 2008

(54) Electrochemical air cell batteries with air flow channels

(75) Inventor: James X. Wu, North Olmsted, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 11/584,855

(22) Filed: Oct. 23, 2006

(51) Int. Cl. H01M 12/06; H01M 2/12

(52) U.S. Cl. 429/27; 429/82; 429/86

(57) ABSTRACT

Air depolarized electrochemical cells are formed having a cell construction for improving or enhancing air flow to an air electrode. The electrochemical cell includes a layer of material disposed between a positive air electrode and an inner surface of a base of a cell casing, and having a surface facing the base, with the layer of material being an air permeable, hydrophobic layer or an air and water permeable layer. At least one of the inner surface of the base and the surface of the layer of material facing the base comprises at least one projection or at least one groove or a combination thereof whereby an open air channel is provided between the inner surface of the base and the layer of material, with the air channel being in contact with at least one air aperture of the cell. Methods for producing air depolarized electrochemical cells having air flow channels are disclosed.

### FIELD OF THE INVENTION

The present invention relates to air depolarized electrochemical cells, and more particularly to cell constructions for improving or enhancing air flow to an air electrode. Methods for producing air depolarized electrochemical cells having air flow channels are disclosed.

### BACKGROUND OF THE INVENTION

Electrochemical air cells, such as prismatic cells and button cells, are stable, relatively high energy density sources and can be utilized in a variety of electronic devices. Non-limiting examples of such electronic devices include hearing aids, watches, hand-held calculators and games, toys, and portable communications devices such as pagers, cellular telephones, etc. Typical electrochemical air cells have a negative electrode (anode) including an anode casing and a positive air electrode (cathode) including a cathode casing. Both the anode casing and the cathode casing have similarly shaped bodies such as a pan or a cup, each with a closed end and an open end generally opposite the closed end. The negative electrode typically employs a metal such as zinc or a zinc alloy as the active material and an alkaline electrolyte, such as potassium hydroxide. The anode casing is inserted into the cathode casing after all the cell materials are placed at desired locations within the anode and cathode casing with an electrically insulating material such as a gasket therebetween, wherein the cell is sealed generally by crimping. An ion permeable separator is typically disposed between the positive air electrode and negative electrode.

Air electrodes for air-depolarized cells often utilize an air permeable, water impermeable layer disposed between an air aperture in the cathode casing and a catalytic layer serve as an air transport layer and an electrolyte leakage barrier. Polytetrafluoroethylene film has been utilized as the air permeable, water impermeable layer or hydrophobic layer. One or more such hydrophobic layers can be included in an electrochemical air cell. One hydrophobic layer is bonded or laminated to the catalytic layer. A second hydrophobic layer, which can be a loose layer, not bonded to the first hydrophobic layer, can be present between the air electrode layer and at least one aperture in the cathode casing. An air distribution layer or pad, that can be air and water permeable, can also be present between the air aperture(s) and the positive air electrode.

In zinc-air electrochemical battery cells, oxygen in the air is utilized as the active cathode material. Oxygen has to diffuse through one or several layers of materials to reach the reactive site, the positive air electrode. The layers of materials, with examples including an air distribution layer, a loose hydrophobic layer, and a bonded hydrophobic layer, or a combination thereof, can restrict oxygen flow to the catalytic layer, where oxygen is reduced during cell discharge, and thus limit cell maximum current density. The hydrophobic layers are generally less permeable to oxygen than the air distribution layer. The restriction of air flow can limit usage of zinc air batteries in high rate applications. Various approaches have been taken in order to supply the positive air electrode with air, preferably on a continuous basis.

Conventional steps taken to increase or enhance air flow include reducing material thickness of various layers, using materials with high diffusion coefficients, and reducing laminating pressure during the air electrode manufacturing process. These approaches have limitations. For example, to maintain desired structural integrity, provide proper sealing and handling properties, the cell materials cannot be too thin, and in order to maintain sufficient peel strength, the laminating pressure cannot be too low.

U.S. Patent Application Publication No. 2005/0196663 relates to a rectangular air battery that includes a first case having a bottom with air holes; a second case; and an insulating gasket with a substantially U-shaped cross-section. The first case and the second case are joined such that the opening of the second case faces the bottom of the first case, and are sealed by crimping the opening edge of the sidewalls of the first case onto the outer face of the second case, with the outer sidewalls of the insulating gasket interposed therebetween. A rib is provided on the bottom of the first case so as to protrude inward inside the first case. The rib extends along the four sidewalls of the first case and supports the inner lower end of the inner sidewalls of the insulating gasket, with at least a separator interposed therebetween.

U.S. Patent Application Publication No. 2004/0048145 relates to a battery that includes an air electrode and an air access passageway that is closed by a non-liquid valve actuable by differential pressure to provide an opening therein to admit air to the battery.

U.S. Pat. No. 6,660,418 relates to a battery powered device providing in combination (1) a cell pack that includes one or more isolation passageways (diffusion tubes) positioned to protect metal-air cells of the battery pack from the ambient air when no air mover is active to force air to the cells and the passageway or passageways remain unsealed, and (2) an electrical device configured to removably receive the cell pack in a manner which allows an air mover associated with the electrical device to communicate with at least one of the isolation passageways of the cell pack to provide air to air electrodes of the cells.

U.S. Pat. No. 6,558,828 relates to an air cell, and the method of forming the air cell, is provided. The cell has a reportedly uniformly laminated hydrophobic membrane using a high laminating force. The air cell reportedly has increased performance in high humidity or low humidity conditions.

U.S. Pat. No. 5,795,667 relates to metal-air electrochemical cells wherein one or more air entry ports are located in the bottom of the cathode can, to provide for entry of oxygen-rich air into the cathode can, where the oxygen participates in the chemical reaction whereby the cell produces electrical energy. Multiple small air entry ports are provided. Generally, the use of multiple ports distributed over the bottom of the cathode can, opposite the reaction surface of the cathode assembly, while not increasing the overall open area of the ports, reportedly result in an increase in the ratio of the cell limiting current to the rate at which moisture is lost from the cell. Accordingly, moisture loss as a function of electrical energy produced, is reduced. The air entry ports reportedly have a stepped cross-sectional opening that provides a larger diffusion area controlling diffusion of air into and out of the cell through a covering tab prior to the cell being put into use, and a smaller untabbed diffusion area controlling diffusion of air into and out of the cell when the cell is in use.

U.S. Pat. No. 5,733,677 relates to a metal-air electrochemical cell comprising an oxygen reservoir disposed in an air plenum adjacent the air cathode. The oxygen reservoir includes an oxygen binding compound characterized in that the oxygen binding compound reportedly reversibly binds oxygen and releases oxygen into the air in the air plenum to power the cell when the partial pressure of oxygen in the air plenum drops due to a load on the cell.

U.S. Pat. No. 5,451,473 relates to a metal-air cell that reportedly provides high currents on an intermittent basis to electrical loads connected thereto. In one embodiment a restrictive membrane is supported by the bottom of the cathode can, and is separated from an air cathode assembly disposed within the cell by an air reservoir. The air reservoir reportedly provides sufficient oxygen to the air cathode assembly during periods of high current drain upon the cell. Upon returning to low drain conditions, the air reservoir is gradually replenished by air flowing through the restrictive membrane at a controlled rate.

In view of the above approaches, the need exists for electrochemical air cells having cell constructions which offer improved or enhanced air flow to an air electrode.

### SUMMARY OF THE INVENTION

An object of the present invention is to provide an electrochemical cell, such as a prismatic cell or button cell, having a construction wherein air flow or diffusion to the air electrode is enhanced, thereby enabling the cell to be utilized in high-rate applications, if desired.

Yet another object of the present invention is to provide an electrochemical air cell having open air channels in the interior of the cell to promote air flow to the positive air electrode.

Another object of the present invention is to provide an electrochemical air cell with a cathode casing having an inner surface comprising a projection or a groove or both, that creates an open air channel with another cell component, with the open air channel extending from an air aperture to direct or enhance air flow in the cell.

A further object of the invention is to provide an electrochemical air cell having a positive electrode casing having a base and a cell component located immediately adjacent to the base, between the base and an air electrode, wherein at least the inner surface of the base and an opposing surface of the cell component comprise a projection or groove or a combination thereof, that form an open air channel in contact with the air aperture.

Still a further object of the present invention is to provide an electrochemical cell having a membrane layer with a textured surface located between a base of a positive electrode casing and a hydrophobic layer of an air electrode that provides an open air channel in at least one area between the base and the hydrophobic layer.

Yet another object of the invention is to provide a method for forming an air electrode of an electrochemical cell having a hydrophobic layer bonded to the air electrode catalytic layer and including areas of different diffusion coefficients. In a preferred embodiment, the method includes laminating the hydrophobic layer to the catalytic (active) layer of the air electrode utilizing a laminating member comprising a first surface and at least one area recessed or projecting from the first surface.

In view of the above, one aspect of the invention is an air depolarized electrochemical cell, comprising a positive air electrode; a negative electrode; a separator disposed between the negative electrode and the positive air electrode; a first casing in electrical contact with the positive air electrode, said first casing having an open end, a closed end comprising a base and a sidewall extending between the closed end and the open end, said base comprising an inner surface, an outer surface, and at least one air aperture extending between the inner surface and the outer surface; a second casing in electrical contact with the negative electrode; and an insulating gasket disposed between the first and second containers; wherein only a single cell is present in the first and second casings; said cell comprises a layer of material disposed between the positive air electrode and the base inner surface and located immediately adjacent to and having a surface facing the base, said layer of material being a member selected from the group consisting of a) an air permeable, hydrophobic layer and b) an air and water permeable layer; at least one of the inner surface of the base and the surface of the layer of material facing the base comprising at least one projection or at least one groove or a combination thereof whereby an open air channel is provided between the inner surface of the base and the layer of material immediately adjacent to the base, said air channel in contact with at least one air aperture; and with the proviso that said base outer surface is free of an indentation therein opposite and corresponding to any said air channel providing projection in said inner surface and free of a projection opposite and corresponding to any said air channel providing groove in said inner surface.

As used herein, a single cell can be a cell with a single positive electrode and a single negative electrode or a bicell in which a single central electrode is shared by two opposite polarity electrodes, located on either side of the central electrode. A preferred bicell has a single negative electrode and two positive air electrodes, each on opposite sides of the negative electrode. In a preferred embodiment of a bicell, the cell has two positive casings, one in electrical contact with each of the two air electrodes and both having at least one aperture. A bicell is useful for reducing the current density during discharge, thereby increasing the current and power the battery can deliver, without changing the nominal cell voltage.

Another aspect of the invention is an air depolarized electrochemical cell, comprising a positive air electrode comprising (a) an active layer comprising a catalytically active material and a binder, and (b) a hydrophobic layer laminated to the active layer; a textured membrane layer; and a positive electrode casing in electrical contact with the air electrode, said casing comprising at least one air aperture in a base of the casing; wherein said textured membrane layer is disposed between the base and the hydrophobic layer and provides an air channel in at least one area between the base and the hydrophobic layer.

In yet another aspect of the invention, a process for making an air depolarized electrochemical cell is disclosed, comprising the steps of providing an active layer of an air electrode comprising a catalytically active material and a binder; providing an air permeable, hydrophobic layer; and laminating the air permeable, hydrophobic layer to the active layer utilizing a laminating member comprising a first surface and at least one area recessed or projecting from the first surface and forming at least one area on the air permeable, hydrophobic layer having at least one surface recessed or projecting from a first surface of the hydrophobic layer.

These and other features, advantages, and objects of the present invention will be further understood and appreciated by those skilled in the art by reference to the following specification, claims, and appended drawings.

### BRIEF DESCRIPTION OF THE DRAWINGS

The invention will be better understood and other features and advantages will become apparent by reading the detailed description of the invention, taken together with the drawings, wherein:

FIG. 1 is an elevational view, in cross-section, of one embodiment of a prismatic-type air electrochemical cell including a positive electrode casing having a projection that forms an open air channel between an inner-surface of the casing and a cell component layer immediately adjacent to the inner-surface;

FIG. 2 is a top view of the inner surface of the positive electrode casing illustrated in FIG. 1;

FIG. 3 is an elevational view, in cross-section, of one embodiment of a button-type air electrochemical cell having a positive electrode casing with grooves that form open air channels between an inner surface of the casing and a layer immediately adjacent of the inner surface;

FIG. 4 is a top view of the inner surface of the positive electrode casing of FIG. 3 particularly illustrating grooves therein which form a portion of the air channels of the electrochemical cell;

FIG. 5 is a partial elevational view, in cross-section, of a positive electrode casing of a button-type air electrochemical cell having a textured loose layer providing open air channels between an inner surface of the positive electrode casing and a surface of the loose layer facing the inner surface;

FIG. 6 is an elevational view, in cross-section, of a positive electrode casing of a button-type air electrochemical cell having a textured bonded layer;

FIG. 7 is an elevational perspective view of a laminating member comprising a first surface and at least one area recessed from the first surface;

FIG. 8 is an elevational perspective view of one embodiment showing an inner surface of a positive electrode casing including ridge projection; and

FIG. 9 is a top view of one embodiment of an inner surface of a positive electrode casing including grooves connected to an air aperture of the casing for enhancing air flow to an air electrode.

### DETAILED DESCRIPTION OF THE INVENTION

The present invention relates to electrochemical cells, particularly fluid depolarized cells, including an air electrode. A cell can have a casing structure that is not limited and can be a cylindrical cell, such as a button-type cell; a flat cell; or a prismatic cell. Button-type cells are generally cylindrical in shape and have maximum diameters that are greater than their total heights. Flat cells or prismatic cells are typically rectangular in shape, but are not limited thereto, and can be square and have a length substantially equal to a width of the cell or otherwise can be non-cylindrical in shape. Preferred cell types include metal-air cells, such as zinc-air cells that contain zinc as a negative electrode active material and utilize oxygen from the surrounding atmosphere as a positive electrode active material.

FIG. 1 illustrates one embodiment of a prismatic electrochemical battery cell 10 including a positive air electrode casing 12. Casing 12 is generally metal and can be formed of one or more, same or different, layers of metal, with examples including, but not limited to nickel, nickel plated steel, stainless steel, and nickel plated stainless steel, with nickel plated steel being preferred. Positive electrode casing 12 is generally prismatic shaped, preferably rectangular, and is formed having four linear or non-linear sidewalls connected to a central region or base 14. Base 14 can be planar or can include single or multiple steps if desired. Casing 12 has an inner surface 15 and an outer surface 16. At least one air aperture 18 extends between inner surface 15 and outer surface 16 of casing 12, preferably in base 14 to admit a fluid, i.e. air, into the cell 10. Casing 12 includes a projection 20 of the present invention that extends out from or protrudes from an inner surface 15 of base 14 as further described herein. Contained within the cell 10 are a positive air electrode 34 and a negative electrode 42, separated by a separator 36.

Electrochemical cell 10 in one embodiment optionally, but preferably, includes a layer of material 30 between the positive air electrode 34 and base 14, immediately adjacent to the base 14, with one or more projections 20 therebetween, when present. Layer of material 30 is preferably a sheet, and can be an air permeable, hydrophobic layer or an air and water permeable layer.

As illustrated in FIG. 1, layer 30 is preferably one or more loose layers that are not laminated or otherwise connected or bonded to the central portion of the air electrode 34. Examples of suitable materials for loose layer 30 include, but are not limited to, porous paper or fibers when the layer 30 is an air distribution layer, or a air permeable hydrophobic membrane such as polytetrafluoroethylene (PTFE) when the layer 30 is a hydrophobic air diffusion layer. In some preferred embodiments, the peripheral portion of layer 30 can be bonded to the air electrode or the inner surface of casing 12.

The air electrode 34 includes a catalytic active layer 35 that may be any material suitable for use in an air electrode, but is preferably a mixture of carbon, manganese oxide (MnOₓ), and a binder such as tetrafluoroethylene (TFE). The catalytic mixture also optionally contains a surfactant often present in the TFE when blended with the other ingredients of the catalytic layer 35. Air electrode 34 preferably includes a hydrophobic layer 32. The hydrophobic layer 32 can be bonded, such as by pressure lamination, on the underside of air electrode 34 and is thus affixed to surface of the active layer 35 and faces at least one air aperture 18. Bonded layer 32 is an air permeable, hydrophobic membrane, preferably PTFE in one embodiment. Air electrode 34 preferably contains a current collector 37, which can be a metal screen or expanded metal, preferably made of nickel, embedded in the catalytic layer 35.

The one or more projections 20 are disposed between casing inner surface 15 and a cell component disposed immediately adjacent to the inner surface 15. The cell component can be one of the air electrode 34, preferably the bonded layer 32, or a layer of material 30, such as a water and air permeable air distribution layer or an air permeable, air diffusion layer.

A projection 20 can be formed of the same material as casing 12 or can be formed of a different material, and preferably deposited or connected to casing 12 after forming. For example, a deposited projection can be a polymer, adhesive, solder, or paper, and combinations thereof. In one embodiment the projection is a screen such as a metal or plastic screen or perforated sheet with multiple openings across its surface. The at least one projection 20 can have the form of a post, hump, dot, ridge, rib, etc. Accordingly, the shape or the form of each projection is not limited and can, independently, have walls or boundaries that are linear or non-linear along the length, height, or width thereof. In a preferred embodiment the projection(s) 20 are in the form of posts or ridges deposited on the inner surface 15 of casing 12.

The height of a projection 20 extending outwardly from the inner surface 15 of the casing 12 is sufficient to form an open air channel 22 between inner surface 15 and the adjacent cell component. The term “open” means that the channel is a space free of material. The projections 20 typically extend by about 0.02 mm to 0.2 mm from the inner surface 15. In a preferred embodiment, at least one open air channel 22 is in contact with an air aperture 18 so that air is able to flow directly from the air aperture 18 to channel 22. The at least one projection 20 can extend generally any length, but is preferably free of contact with a sidewall 13 of casing 12. Accordingly, air is free to flow along the sidewalls 13 of the casing 12. The length of a projection 20 can vary, and can be the same or different from another projection, if present. The width of a projection can also vary at any point along a length thereof as desired. Various patterns can be formed with one or more projections 20, such as shown in FIG. 2 in order to create a desired air flow path to direct or enhance air flow with the cell 10. A goal of the at least one projection or groove, described herein, is to prevent or minimize “dead spots” or areas where air does not easily flow to the air electrode 34. The shapes, spacing and orientation of the projections will also be such that channels remain open during cell discharge. In one embodiment, at least one projection 20 is formed as a ridge, preferably with the ridge projection 21 having a portion that is deposed between two air apertures 18, as shown in FIGS. 2 and 8. In another embodiment, multiple projections 20 are formed as posts distributed around each of the apertures 18.

In one embodiment of a cell, it is desirable to utilize a single air aperture 18 near the center area of the casing base 15 and two or more projections 20 preferably shaped as ridges, or grooves 120 are present and are situated between the air aperture 18 and sidewall of the casing, preferably extending a majority of the distance between the air aperture and casing sidewall, see FIG. 9. In yet another embodiment as shown in FIG. 8, a plurality of projections 20 are present, namely a pair of elongated “C”-shaped ridge projections, with the projections 20 extending between a plurality of the numerous air apertures 18 present.

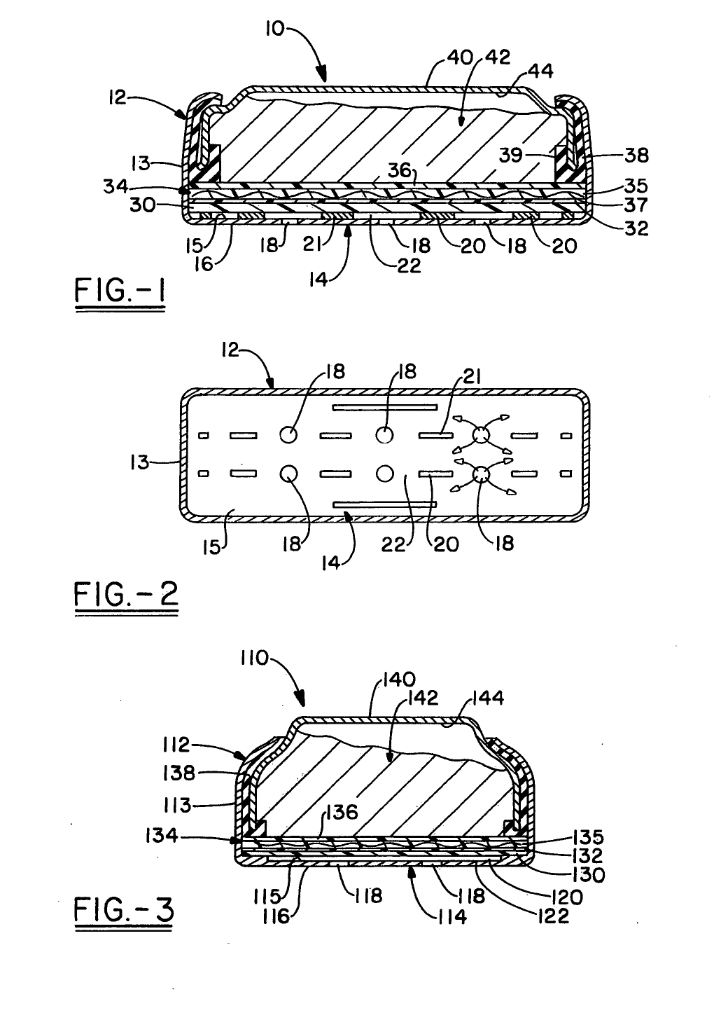

FIGS. 3 and 4 illustrate one embodiment of a button-type cell 110 including a positive electrode casing 112 that can be formed of one or more materials such as described hereinabove with respect to casing 12. Casing 112 is substantially cylindrical, i.e. a cup-shaped component, having a base 114, which is preferably a flat central region surrounded by an upstanding wall 113 of uniform height. Alternatively, in one embodiment base 114 can have a portion that may be formed to protrude outward from the peripheral part of the casing bottom. At least one air aperture 118 is present in base 114 and extends between inner surface 115 and outer surface 116 of casing 112 to act as an air entry port.

Likewise, electrochemical cell 110 in one embodiment optionally, but preferably, includes a layer of material 130 having the characteristics of material 30 described hereinabove. Cell 110 also has an air electrode 134 that includes a bonded layer 132 and a catalytic layer 135 as described hereinabove with respect to air electrode 34, bonded layer 32 and catalytic layer 35.

Cell 110 includes at least one groove 120 in the inner surface 115 of casing 112 extending from air aperture 118 and adapted to receive air therefrom for distribution within the cell 110. Groove 120 is a depression, recess, indentation, trough, etc. in the inner surface 115 of the base 114. An open air channel 122 is formed between inner surface 115 of base 114 and the cell component immediately adjacent to the inner surface of the base. The cell component can be, for example, a portion of the air electrode 134, such as bonded layer 132 thereof; or another layer of material 130, preferably a loose layer not bonded to the central portion of air electrode 134, such as an air diffusion layer or an air distribution layer. Accordingly, the top of air channel 122 is bounded by a cell component and the remainder of air channel 122 is bounded by a portion of base 114 in one embodiment.

In a preferred embodiment, at least one groove 120, and more preferably two or more grooves 120 are present in the inner surface 115 of base 114, such as shown in FIG. 4, wherein four grooves 120a-120d are illustrated. In order to promote air flow and air distribution to air electrode 134, at least one groove 120 is directly connected to or in contact with one or more air apertures 118, such as illustrated. Each groove 120a-120d extends across two air apertures 118 as shown in FIG. 4. A further embodiment illustrating air grooves 120 formed in the inner surface 115 of a base 114 of a button-type cell is illustrated in FIG. 9. In this case, base 114 has only a single air aperture 118, generally at the radial center of the base 114, with grooves 120 extending outward, in this case radially, from the air aperture 118.

A groove 120 need not be linear as shown in FIGS. 4 and 9, and it is to be understood and appreciated that the shape or form of groove 120 is not limited and can have walls or boundaries that are linear or non-linear along a length, width, or depth thereof such as an arc, curve, wave pattern, etc., or combinations thereof. The length of a groove 120 can also vary and when two or more grooves 120 are present, the length of each groove 120 can be the same as or different from any other groove 120 as desired. The width of a groove 120 likewise can be the same as or vary from one groove to another when two or more grooves 120 are present in a base of a cell casing. The width of a groove 120 can also vary at any point along the length thereof as desired. A groove 120 is preferably free of contact with the sidewall 113 or casing 112. The depth of a groove 120 likewise can vary along a length or width thereof as desired. The depth of a first groove can be the same as or different from a second groove when present. A groove 120 can be formed in a base 114 of the positive electrode casing 112 using any suitable method, with examples including, but not limited to, stamping, grinding, drilling, etching, etc., with stamping being preferred.

In one aspect of the present invention, the base 14, 114 outer surface 16, 116 of casing 12, 112 is free of an indentation therein opposite and corresponding to any open air channel providing projection 20 on the inner surface 15, 115 of casing 12, 112 and free of a projection extending therefrom opposite and corresponding to any open air channel providing groove 120 in the inner surface 15, 115 of the casing 12, 112. The term “opposite and corresponding to” means a location on one surface, an outer or inner surface, of the casing base has a contrary location, on the inner or outer surface, respectively, substantially perpendicular to the plane of the base in the area of the respective locations, i.e. complementary positions on the inner and outer sides of the casing.

At least one layer of separator 36, 136 is preferably positioned above air electrode 34, 134 generally opposite bonded layer 32, 132. Cell 10, 110 also includes a negative electrode casing 40, 140 which forms the top of the cell. Negative electrode casing 40, 140 is preferably formed of a substrate including material having a sufficient mechanical strength for the intended use. The negative electrode casing 40, 140 is preferably a metal of one or more layers. In one embodiment, the negative casing 40, 140 is a laminate comprising, for example, from exterior layer to interior layer, nickel/steel/nickel, tin/nickel/steel/nickel/tin, tin/copper/stainless steel/tin, tin/nickel/stainless steel/copper/tin, stainless steel/copper, tin/stainless steel/copper/tin, tin/nickel/stainless steel/nickel/copper/tin, or nickel/stainless steel/nickel/copper, copper/stainless steel/copper or variations thereof. As known in the art, negative electrode casing 40, 140 can be a straight walled anode casing that has a terminal end that defines an opening in the negative electrode casing, or a refold negative electrode casing. Refold negative electrode casings generally have a rounded rim that is substantially U-shaped at the end that defines the opening therein, and is generally formed in one embodiment by folding a portion of the wall of the casing back upon itself so that the opening in the casing is defined by the folded rim. The formed casings can be post plated with another metal or alloy to minimize hydrogen gassing within the cell and/or improve the corrosion resistance or appearance of the external surface of the casing.

During manufacture of the cell 10, 110, negative electrode casing 40, 140 is preferably inverted, and then a negative electrode composition or anode mixture 42, 142 and electrolyte are placed in anode casing 40, 140. In a prismatic cell, the wet and dry components of the anode mixture are preferably blended beforehand and then dispensed in one step into the negative electrode casing 40, 140. In a button cell, such as described herein below, the anode mixture insertion is preferably a two step process wherein dry anode mixture materials are dispensed first in to the casing 40, 140 followed by addition of the electrolyte, such as a KOH solution. Electrolyte can creep or wick along the inner surface 44, 144 of casing 40, 140, carrying with it materials contained in active anode mixture 42, 142 and/or the electrolyte.

The electrolyte composition for a button cell is preferably a mixture of about 97 weight percent potassium hydroxide (KOH) solution where the potassium hydroxide solution is 28-40 weight percent, preferably 30-35 weight percent, and more preferably about 33 weight percent aqueous KOH solution, about 3.00 weight percent zinc oxide (ZnO), and a very small amount of CARBOWAX® 550, which is a polyethylene glycol based compound available from Union Carbide Corp., preferably in an amount of about 10 to 500 ppm, more preferably about 30 to 100 ppm, based on the weight of zinc composition in the anode.

The anode mixture 42, 142, for a prismatic cell comprises a mixture of zinc, electrolyte, and organic compounds. The anode mixture 42, 142 preferably includes zinc powder, electrolyte solution, a binder such as CARBOPOL® 940, and gassing inhibitor(s) such as indium hydroxide (In(OH)₃) and DISPERBYK® D190 in amounts of about 60 to about 80 weight percent zinc, about 20 to about 40 weight percent electrolyte solution, about 0.25 to about 0.50 weight percent binder, about 0.045 weight percent indium hydroxide and a small amount of DISPERBYK® D190, preferably in an amount of about 10 to 500 ppm, more preferably about 100 ppm, based on the weight of zinc. DISPERBYK® D190 is an anionic polymer and is available from Byk Chemie of Wallingford, Conn.

The electrolyte composition for a prismatic cell is preferably a mixture of about 97 weight percent potassium hydroxide (KOH) solution where the potassium hydroxide solution is about 28 to about 40 weight percent, preferably about 30 to about 35 weight percent, and more preferably about 33 weight percent aqueous KOH solution, and about 1.00 weight percent zinc oxide (ZnO).

The anode mixture 42, 142, for a button cell comprises a mixture of zinc, electrolyte, and organic compounds. The anode mixture 42, 142 preferably includes zinc powder, a binder such as SANFRESH™ DK-500 MPS, CARBOPOLS 940 or CARBOPOL® 934, and a gassing inhibitor such as indium hydroxide (In(OH)₃) in amounts of about 99.7 weight percent zinc, about 0.25 weight percent binder, and about 0.045 weight percent indium hydroxide. SANFRESH™ DK-500 MPS is a crosslinked sodium polyacrylate from Tomen America Inc. of New York, N.Y., and CARBOPOL® 934 and CARBOPOL® 940 are acrylic acid polymers in the 100% acid form and are available from Noveon Inc. of Cleveland, Ohio.

Preferred zinc powders are low-gassing zinc compositions suitable for use in alkaline cells with no added mercury. Examples are disclosed in U.S. Pat. No. 6,602,629 (Guo et al.), U.S. Pat. No. 5,464,709 (Getz et al.) and U.S. Pat. No. 5,312,476 (Uemura et al.), which are hereby incorporated by reference.

One example of a low-gassing zinc is ZCA grade 1230 zinc powder from Zinc Corporation of America, Monaca, Pa., USA, which is a zinc alloy containing about 400 to about 550 parts per million (ppm) of lead. The zinc powder preferably contains a maximum of 1.5 (more preferably a maximum of 0.5) weight percent zinc oxide (ZnO). Furthermore, the zinc powder may have certain impurities. The impurities of chromium, iron, molybdenum, arsenic, antimony, and vanadium preferably total 25 ppm maximum based on the weight of zinc. Also, the impurities of chromium, iron, molybdenum, arsenic, antimony, vanadium, cadmium, copper, nickel, tin, and aluminum preferably total no more than 68 ppm of the zinc powder composition by weight. More preferably, the zinc powder contains no more than the following amounts of iron, cadmium, copper, tin, chromium, nickel, molybdenum, arsenic, vanadium, aluminum, and germanium, based on/the weight of zinc: Fe—3.5 ppm, Cd—8 ppm, Cu—8 ppm, Sn—5 ppm, Cr—3 ppm, Ni—6 ppm, Mo—0.25 ppm, As—0.1 ppm, Sb—0.25 ppm, V—2 ppm, Al—3 ppm, and Ge—0.06 ppm.

In a further embodiment, the zinc powder preferably is a zinc alloy composition containing bismuth, indium and aluminum. The zinc alloy preferably contains about 100 ppm of bismuth, 200 ppm of indium, and 100 ppm of aluminum. The zinc alloy preferably contains a low level of lead, such as about 35 ppm or less. In a preferred embodiment, the average particle size (D₅₀) is about 90 to about 120 microns. Examples of suitable zinc alloys include product grades NGBIA 100, NBBIA 110, NGBIA 115, and BIA available from N.V. Umicore, S.A., Brussels, Belgium.

While the cells of the present invention can include added mercury, for example about 3% mercury based on the weight of zinc, it is desirable that the only mercury contained in the preferred cells of this invention is that which is naturally present in the cell components. That said, in a preferred embodiment, the cells of the present invention include mercury in an amount generally less than 50 parts per million by total weight of the cell, desirably less than 10 parts per million, preferably less than 5 parts per million, and more preferably less than 2 parts per million. U.S. Pat. No. 6,602,629 to Guo et al., herein fully incorporated by reference, discloses the method used to determine the total level of mercury in a cell.

Cell 10, 110 also includes a gasket 38, 138 made from a dielectric material, preferably an elastomeric material which serves as a seal between positive electrode casing 12, 112 and negative electrode casing 40, 140. Bottom edge of gasket 38, 138 has been formed to create a lip 39 that butts the rim of negative electrode casing 40, 140. Optionally, a sealant may be applied to the sealing surface of the gasket, positive electrode casing and/or negative electrode casing. Suitable sealant materials will be recognized by one skilled in the art. Examples include asphalt, either alone or with elastomeric materials or ethylene vinyl acetate, aliphatic or fatty polyamides, polyolefins such as polyethylene or polypropylene, polyamine, and polyisobutylene. A preferred sealant is SWIFT® 82996 from Forbo Adhesives, LLC of Research Triangle Park, N.C.

The positive electrode casing 12, 112, including the inserted air electrode 34, 134 and associated membranes 30, 32, 130, 132 is inverted and pressed against the anode casing/gasket assembly, which is preassembled with the casing 40, 140 inverted so the rim of the casing faces upward. While inverted, the edge of the positive electrode casing 12, 112 is deformed inwardly, so the rim of the cathode casing is compressed against the elastomeric gasket 38, 138, which is between the positive electrode casing 12, 112 and the negative electrode casing 40, thereby forming a seal and an electrical barrier between the casings 12, 112.

Any suitable method may be used to deform the edge of the casing inward to seal the cell, including crimping, colleting, swaging, redrawing, and combinations thereof as appropriate. Preferably the button cell is sealed by crimping or colleting with a segmented die so that the cell can be easily removed from the die while a better seal is produced. As used herein, a segmented die is a die whose forming surfaces comprise segments that may be spread apart to enlarge the opening into/from which the cell being closed is inserted and removed. Preferably portions of the segments are joined or held together so they are not free floating, in order to prevent individual segments from moving independently and either damaging the cell or interfering with its insertion or removal. Preferred crimping mechanisms and processes are disclosed in commonly owned U.S. Pat. No. 6,256,853, which is hereby incorporated by reference. Preferably a prismatic cell is sealed by crimping.

A suitable tab (not shown) can be placed over the air aperture 18, 118 until the cell 10, 110 is ready for use to keep air from entering the cell 10, 110 before use.

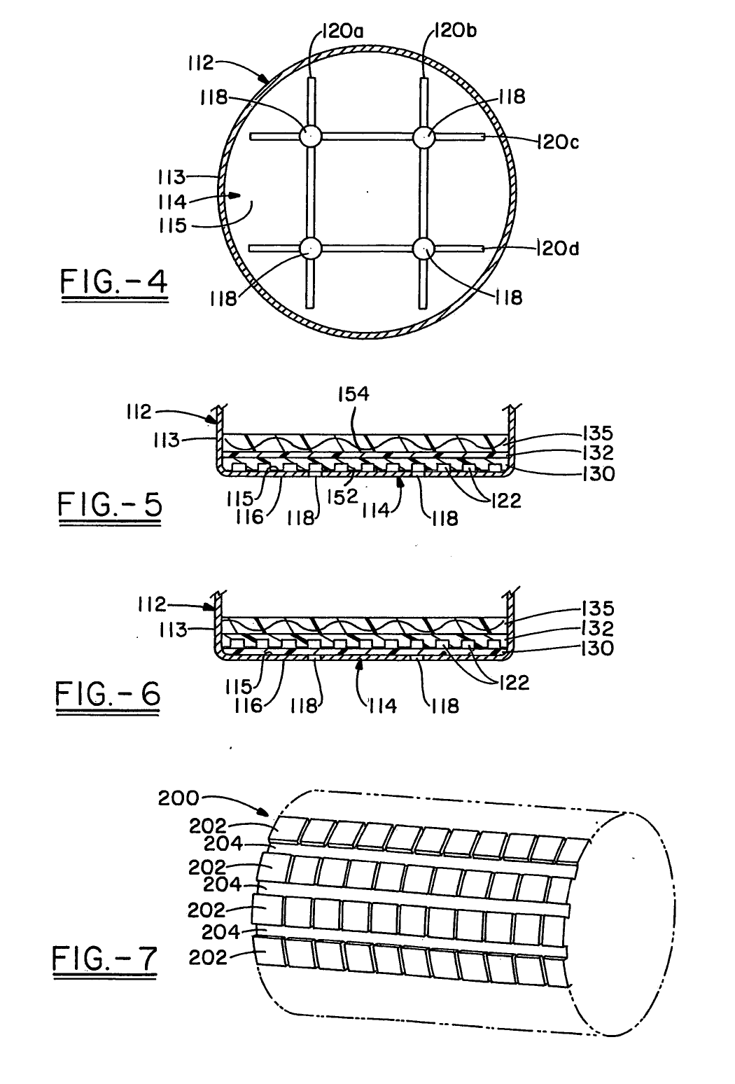

In yet a further embodiment of the present invention, the loose layer 30, 130 situated between the base 14, 114 and the positive air electrode 34, 134, prior to use in the cell, is provided with a textured surface forming an open air channel 22, 122 with another cell component such as casing 12, 112 or bonded layer 32, 132 when assembled in the cell. FIG. 5 illustrates one embodiment of layer 130 having a textured surface on a lower side of the layer 130 facing the base 114, inner surface 115. Any portion of layer 130 can have a texture including upper surface 152 or lower surface 154.

The texture can be present upon forming the layer 130, such as when formed using a casting or molding method, or the texture can be imparted after the material has been formed, for example, by selective removal of material such as through etching, addition of material such as by auto deposition, or by embossing, for example, utilizing a forming member such as a roller having a desired texture, such as a first surface and a second surface projecting or recessed from the first surface.

The texture of layer 130 can be a pattern, series of patterns, or a random form, etc. and is not limited to a specific form so long as an open air channel 122 is formed between the layer 130 and either the base 114 or a portion of the air electrode 134 such as bonded layer 132 or both when the cell is assembled. In one embodiment, for example when a textured roller is utilized to impart a texture to the layer 130, the textured material can have, prior to use in the cell, at least two areas having different diffusion coefficients, due to the compression of portions of the material. Preferably at least one open air channel 122 is in contact with an air aperture 118 of casing 112. When two or more air channels are present, the length of one air channel can be the same or different as any other air channel present. Similarly, the width and depth of each air channel 122 formed in layer 130 can vary and can be same or different than another air channel when present in layer 130.

In a preferred embodiment, the perimeter area of the layer 30, 130 preferably adapted to be situated below a sealing gasket of the cell 10, 110 such as gaskets 38 and 138 shown in FIGS. 1 and 3, is compressed, prior to use in the cell, and has a lower diffusion coefficient than an uncompressed area or an area that is compressed less than the perimeter area. A compressed perimeter area aids in the ability to adequately seal a cell and substantially prevent leakage.

In yet a further embodiment of the present invention, a component of the air electrode assembly, preferably bonded layer 132 is provided with a texture to enhance air flow to the catalytic layer 135, such as shown in FIG. 6. The texture is preferably present in the side or surface of the layer 132 facing the base 114 and the air aperture(s) 118 present therein. The texture on layer 132 can be a pattern or random form, etc, such as described for loose layer 130 hereinabove, and incorporated by reference. Examples of suitable textures include, but are not limited to, at least one area having a different thickness than a thickness of the second area of the layer, wherein at least one open air channel 122 is present in the textured surface. The open air channel 122 is thus formed between bonded layer to an adjacent component of the cell, such as material 130 when present, or base 114 of casing 112, for example. The texture present on the bonded layer can form a groove or projection, or both, such as described hereinabove. Accordingly, such grooves or projections are not limited in shape or form and can be linear or non-linear along any length thereof. The length of any groove or projection on the surface of bonded layer 132 can vary and when two or more grooves or projections are present, the length of each groove or projection can be same or different from any other groove or projection as desired. The width of the groove or projection can likewise can be the same or vary from one groove or projection to another when two or more grooves or projections are present on bonded layer 132. The depth or height of a groove or projection can also vary at any point along the length thereof.

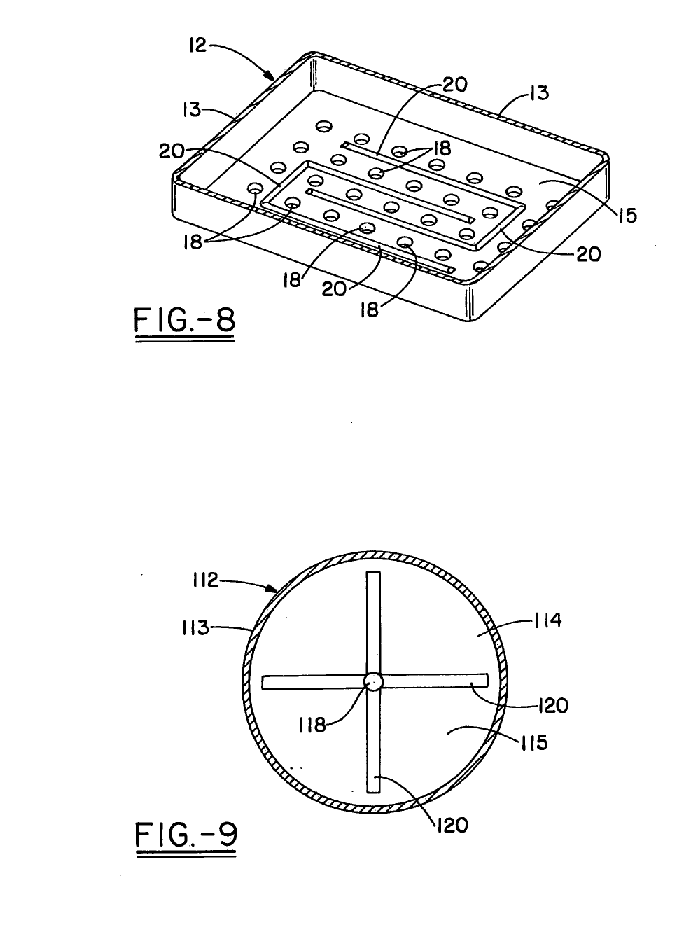

In one preferred embodiment, a process for making the textured bonded layer 132 is as follows. An active layer of an air electrode comprising, such as described above, a catalytically active material, a binder, and a screen is provided. A desired layer to be bonded as described above, is also provided. The layer is bonded to the active layer utilizing a laminating member having a first surface and at least one area recessed or projecting from the first surface, forming at least one area on the layer having at least one area recessed or projecting from a first surface of the layer. The laminating member for example can be a roller, pad, stamp, press, etc. In a preferred embodiment, the laminating member is a roller 200, preferably including a grid formed of repeating recesses or projecting areas. One preferred embodiment of a roller 200 including recessed channels on its surface is illustrated in FIG. 7. As illustrated, roller 200 includes a first surface 202 and second surface 204, wherein second surface 204 is an area recessed from first surface 202. Second surface 204 is a series of recessed channels generally situated at right angles, forming a grid. First surface 202 can be considered a series of islands or blocks. The layer to be bonded, such as a hydrophobic layer as described hereinabove, is contacted with the active layer of the air electrode. Afterwards, the roller 220 is utilized to apply pressure to the layer to be bonded and the second surface 204 does not compress the bonded layer to the active layer with as much pressure when compared to first surface 202. After the laminating process, the area of the bonded layer contacted by second surface 204 is not as compressed as much as the area contacted by first surface 202 of roller 200 and thereby provides the bonded layer with the textured surface, allowing open air channels to be formed when the air electrode and bonded layer are assembled in a cell. The under-compressed area has a relatively high diffusion coefficient and facilitates oxygen diffusion from the air channel(s) present.

The ratio of open air channel area to total area of the bonded, more compressed areas can be optimized for peeling strength and diffusion coefficient. The shape and geometry of the air channels can be optimized by finite element simulation. The open air channels are preferably connected to promote or enhance air flow. The air channels should not be blocked by the expanded discharged active materials. As set forth hereinabove, a perimeter area or sealing area of the bonded layer 32, 132 around the periphery of the electrode is preferably compressed in an area adapted to be situated below a sealing gasket of the cell, thereby aiding in the ability to adequately seal the cell and substantially prevent leakage.

The open air channel configurations of the present invention offer the following advantages. Peel strength between the active material layer of the air electrode and the bonded layer can be maintained without significantly sacrificing permeability of the bonded layer in the area of the channels. The resulting uneven surface texture of the bonded layer of the air electrode maintains an air gap during cell discharge and when the electrode is pressed against the casing due to expanding volume of discharged zinc. The active material of the air electrode can also have a low density area due to a lower amount of compression applied by the textured roller during formation of the air electrode assembly comprising the air electrode 134 and bonded layer 132. The low density area has a high oxygen diffusion coefficient and therefore, current density can be further increased. A further advantage is that the air electrode surface area can be increased if desired. Also, an air diffusion layer can be eliminated if desired. Yet another advantage is the low cost bonded layer materials can be utilized.

It will be understood by those who practice the invention and those skilled in the art, that various modifications and improvements may be made to the invention without departing from the spirit of the disclosed concepts. The scope of protection afforded is to be determined by the claims and by the breadth of interpretation allowed by law.

1. An air depolarized electrochemical cell, comprising:
a positive air electrode;
a negative electrode;
a separator disposed between the negative electrode and the positive air electrode;
a first casing in electrical contact with the positive air electrode, said first casing having an open end, a closed end comprising a base and a sidewall extending between the closed end and the open end, said base comprising an inner surface, an outer surface, and at least one air aperture extending between the inner surface and the outer surface;
a second casing in electrical contact with the negative electrode; and
an insulating gasket disposed between the first and second containers; wherein:
only a single cell is present in the first and second casings; and
said cell comprises a layer of material disposed between the positive air electrode and the base inner surface and located immediately adjacent to and having a surface facing the base, said layer of material being a member selected from the group consisting of a) an air permeable, hydrophobic layer and b) an air and water permeable layer;
the surface of the layer of material facing the base comprises at least one projection or at least one groove or a combination thereof whereby an open air channel is provided between the inner surface of the base and the layer of material immediately adjacent to the base, said air channel in contact with at least one air aperture.

2. The cell according to claim 1, wherein the inner surface of the base includes at least one projection or at least one groove or a combination thereof.

3. The cell according to claim 2, wherein the base inner surface comprises at least one projection having a distal end portion contacting at least one of the a) air permeable, hydrophobic layer, and the b) air and water permeable layer.

4. The cell according claim 1, wherein the layer of material disposed between the positive air electrode and the base inner surface is an air permeable, hydrophobic layer that is either a bonded layer of the air electrode or a loose layer.

5. The cell according to claim 4, wherein the air permeable, hydrophobic layer is polytetrafluoroethylene.

6. The cell according claim 1, wherein the cell comprises an air permeable, hydrophobic layer bonded to the positive electrode and an air permeable, hydrophobic loose layer, and wherein the loose layer is the layer of material immediately adjacent to the base inner surface.

7. The cell according claim 1, wherein the surface of the layer of material facing the base comprises at least one projection, the at least one projection comprising a post, hump, dot, ridge, or rib, or a combination thereof.

8. The cell according claim 1, wherein two or more air apertures are present in the base extending between the inner surface and the outer surface.

9. The cell according claim 3, wherein the at least one projection is a ridge projection.

10. The cell according to claim 9, wherein the at least one ridge projection has a portion that is disposed between two air apertures.

11. The cell according to claim 10, wherein at least one of the at least one ridge projection is a “C”-shaped ridge.

12. The cell according to claim 11, wherein a pair of “C”-shaped ridges are present.

13. The cell according to claim 3, wherein the at least one base inner surface projection is formed of the same material as the first casing.

14. The cell according to claim 3, wherein the at least one base projection from the base inner surface is deposited in the first casing after forming.

15. The cell according to claim 14, wherein the deposited projection comprises a polymer, adhesive, metal, or a combination thereof.

16. The cell according to claim 3, wherein the at least one projection from the base inner surface is a screen.

17. The cell according claim 1, wherein one air aperture is present near a center of the base, and wherein two or more projections are present and are situated on the surface of the layer of material facing the base, between the air aperture and sidewall of the casing.

18. (canceled)

19. The cell according claim 1, wherein a plurality of air apertures are present.

20. (canceled)

21. (canceled)

22. The cell according claim 1, wherein at least one groove is present in the surface of the material facing the base, and wherein the at least one open air channel is created by the at least one groove and the base inner surface.

23. (canceled)

24. (canceled)

25. (canceled)

26. (canceled)

27. (canceled)

28. (canceled)

29. The cell according claim 1, wherein the at least one air channel is provided with at least one groove and at least one projection provided on the surface of the layer of material facing the base.

30. The cell according to claim 1, wherein the cell is a prismatic cell or button cell.

31. The cell according to claim 30, wherein the negative electrode comprises zinc and potassium hydroxide.

32. The cell according to claim 30, wherein the air electrode comprises carbon, manganese oxide, and tetrafluoroethylene.

33. (canceled)

34. (canceled)

35. (canceled)

36. (canceled)

37. The cell according claim 4, wherein the layer of material immediately adjacent to the base inner surface is a loose layer, and the loose layer prior to use in the cell has at least two areas having different diffusion coefficients.

38. The cell according claim 37, wherein the loose layer comprises two or more grooves and two or more projections that form air channels with the base inner surface in the form of a grid.

39. The cell according claim 37, wherein the loose layer has a perimeter having a higher diffusion coefficient than a second area of the loose layer.

40. The cell according to claim 1, wherein the negative electrode comprises a metal disposed within the second casing.

41. The cell according to claim 40, wherein the negative electrode comprises zinc and potassium hydroxide.

42. The cell according to claim 41, wherein the air electrode comprises carbon, manganese oxide, and tetrafluoroethylene.

43. The cell according to claim 1, wherein the single cell has a single negative electrode and a single positive electrode.

44. The cell according to claim 1, wherein the single cell is a bicell with two positive electrodes, each disposed on an opposite side of a single negative electrode.

45. The cell according to claim 1, wherein the cell comprises an air permeable, hydrophobic layer and an air and water permeable layer, and the air and water permeable layer is the layer of material located immediately adjacent to the base.
